(19) United States
(12) Patent Application Publication
(10) Pub. No.: US 2023/0000062 A1
(43) Pub. Date: Jan. 5, 2023

(54) Method for Drawing Fish to View

(71) Applicant: Jason Hill, Miami Beach, FL (US)

(72) Inventor: Jason Hill, Miami Beach, FL (US)

(21) Appl. No.: 17/365,922

(22) Filed: Jul. 1, 2021

(51) Int. Cl. A01K 63/00

(52) U.S. Cl. CPC A01K 63/006

(57) ABSTRACT

A method of drawing aquatic or other animal life in a fish-style tank to a clear side of the tank by providing a shelter structure affixed to an interior wall of the tank that encourages that life to enter by offering protection. The shelter structure does not obstruct people from viewing the fish from outside the tank. Treatments to the walls of the shelter can alter the opacity, color, appearance, shape and other aspects to increase the attractiveness of the shelter to the fish (or other animal), affect the behavior of the fish and provide ornamentation.

### CROSS-REFERENCES TO RELATED APPLICATIONS

None.

### STATEMENT REGARDING FEDERAL SPONSORED RESEARCH OR DEVELOPMENT

None.

### NAMES OF PARTIES TO A JOINT RESEARCH AGREEMENT

None.

### REFERENCE TO A “SEQUENCE LISTING”, A TABLE, OR A COMPUTER PROGRAM LISTING APPENDIX SUBMITTED ON COMPACT DISC AND INCORPORATION-BY-REFERENCE OF THE MATERIAL ON THE COMPACT DISCLOSURE

None.

### STATEMENT REGARDING PRIOR DISCLOSURES BY AN INVENTOR OR JOINT INVENTOR

None.

### BACKGROUND OF THE INVENTION

### 1. Field of the Invention

The present invention relates to viewing life in fish-style tanks, and more particularly, to a device and method of use to draw fish or other animals to a selected location in a tank for better viewing.

### 2. Description of Related Art Including Information Disclosed Under 37 CFR 1.97 and 37 CFR 1.98

Several designs for fish tank accessories and items that interest fish have been designed in the past. Most of these include a variety of products of devices that sit on the bottom of the tank. For example, these may include natural and artificial reefs, simulated structures, real and artificial plants, treasure boxes and small pirate ships. None of these include the features of the present invention that draw a fish to a side wall of a tank to better view the fish.

Applicant believes the closest prior art is found in U.S. Pat. No. 4,531,477 issued to Crossman. However, the Crossman device, among other features, requires a pump and a nozzle directing a curtain of water. In contrast, the present device has no required moving parts and does not require a pump. Further, by Crossman having a pump and moving water that design requires an enclosure to channel the water. An advantage of the present design is that when viewing the life in the tank the observer only has to look through the tank wall and not through any structure of the added device. Additionally, the Crossman device works only when submerged to pump water. The present device and method works in wet or dry tanks.

Applicant also notes U.S. Pat. No. 3,512,503 issued to Willinger disclosing a compartmented fish display case. The present device and method of use differ from Willinger because the Willinger device requires a user to manually place the fish inside the device. The present design draws fish or other life inside the tank to enter the structure of their own free will. This Willinger design is to temporarily display fish for sale and does not permit fish to come and go naturally. Willinger also only works for fish and not other types of animals.

Other patents and prior art describe related subject matter that provide for a number of more or less complicated features that fail to solve the problem in an efficient and economical way. None of these patents suggest the novel features of the present invention.

A brief abstract of the technical disclosure in the specification and title are provided as well for the purposes of complying with 37 CFR 1.72 and are not intended to be used for interpreting or limiting the scope of the claims.

Without limiting the scope of the invention, a brief summary of some of the claimed embodiments of the invention is set forth below. Additional details of the summarized embodiments of the invention and/or additional embodiments of the invention may be found in the detailed description of the invention below.

### BRIEF SUMMARY OF THE INVENTION

It is one of the main objects of the present invention to provide a device and method of use that attaches to an interior surface of a fish tank to draw fish to the side of the tank for better viewing.

It is another object of this invention to provide a device that easily retrofits into any existing tank.

It is still another object of the present invention to provide a device that works with a variety of different species and types of fish to offer those fish a protected environment.

It is yet another object of this invention to provide such a device and associated method of use that is inexpensive to practice, manufacture and maintain while retaining its effectiveness.

Further objects of the invention will be brought out in the following part of the specification, wherein the detailed description is for the purpose of fully disclosing the invention without placing unnecessary limitations thereon.

These and other embodiments which characterize the invention are pointed out with particularity in the claims annexed hereto and forming a part hereof. However, for a better understanding of the invention, its advantages and objectives obtained by its use, reference can be made to the drawings which form a further part hereof and the accompanying descriptive matter, in which there are illustrated and described various embodiments of the invention.

### BRIEF DESCRIPTION OF THE SEVERAL VIEWS OF THE DRAWING

With the above and other related objects in view, the invention exists in the details of construction and combination of parts as will be more fully understood from the following description, when read in conjunction with the accompanying drawings in which:

FIG. 1 shows a perspective view of a fish tank including a prior art example and two embodiments of a device used with the disclosed method.

FIG. 2 shows a perspective view of a section of fish tank side wall including an embodiment of a fish attracting device.

FIG. 3 shows a perspective view of a fish tank having installed alternate embodiments of the present design.

### DETAILED DESCRIPTION OF THE INVENTION

While this invention may be embodied in many different forms, there are described in detail herein specific embodiments of the invention. This description is exemplary of the principles of the invention and is not intended to limit the invention to the particular embodiments illustrated and described.

For the purpose of this disclosure, like reference numerals in the figures shall refer to like features unless otherwise indicated or is obvious by context.

The subject device and method of drawing fish to a side of a fish tank is sometimes referred to as the device, the invention, the fish shelter, the shelter assembly, the tube, the fish attraction device and/or method, the fish feeder, the machine or other similar terms. These terms may be used interchangeably as context requires and from use and drawings the intent becomes apparent. The masculine can sometimes refer to the feminine and neuter and vice versa. The plural may include the singular and singular the plural as appropriate from a fair and reasonable interpretation in the situation.

Referring now to the drawings, where the present invention is generally referred to with numeral 10, it can be observed that it basically includes a shelter assembly 12, a shelter assembly 14, attachment points 16, a panel 18, an edge 20, an edge 22, an edge 24, attachment points 26, a panel 28, a panel 30, a panel 32, a waterline 34, an aperture 36, a tank assembly 38, a panel 40, a panel 42, attachment points 44, a food 46, a rim 48, a joint 50, a panel 52, a joint 54, a panel 56, a joint 58, a panel 60, a flex segment 62, a panel 64, and a corner 66.

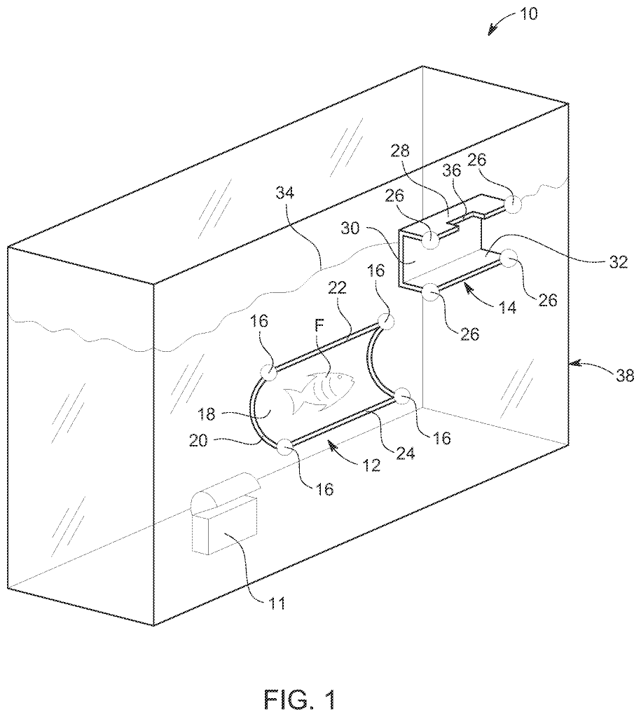

FIG. 1 shows an example of a tank assembly 38 containing an example of prior art 11 and two different embodiments of devices used to practice the subject method including shelter assembly 12 and shelter assembly 14. Generally, the tank assembly 38 is comprised of a rigid material with at least one transparent side to view the contents and that is designed and adapted to contain water, typically embodied as a classic style fish tank.

In the past, fish have been placed in the interior of the tank assembly 38 and are free to wander about the volume of the tank. The fish may interact with prior art structures 11. For example, prior art may include small structures, reefs, vegetation or other articles around which the fish can swim and hide. These often obscure the ability of those who wish to view and enjoy the beauty of aquatic creatures inside the tank because they are often not visible inside and behind the structures.

An important aspect of the present invention provides for a structure attached to a transparent side wall of a tank. The inventive structure is integral to the method for attracting fish to the side wall of the tank for viewing, protection, feeding and general enjoyment of the aquatic life in the tank.

The shelter assembly 12 shown in FIG. 1 is a basic example of a fish attracting structure or shelter. It comprises a panel 18 with a three-dimensional relief and a plurality of attachment points 16. The attachment points 16 connect the shelter assembly 12 to an interior surface of a wall of the tank assembly 38. The relief in the shelter assembly 12 provides a volume between the panel 18 and the wall of the tank assembly 38 to which the shelter assembly 12 is attached. The fish swims into this volume inside the shelter assembly 12 on its own free will. In fact, the design naturally attracts the fish into the volume inside.

This relief area between the panel 18 and the interior wall of the tank assembly 38 provides a space for the fish F (or other aquatic life) to find a sanctuary and refuge. This also positions the fish F in a location adjacent to the wall of the tank assembly 38 that is in a desired location for improved viewing of that aquatic life F through the clear wall of the tank.

The panel 18 of the shelter assembly 12 will also have an edge 20 that defines an entry portal for the fish F to enter the shelter assembly 12. Edges 22 and 24 on the panel 18 are generally close enough to the wall of the tank assembly 38 to which it is attached to partially enclose the interior volume of the shelter assembly so that entry can only be made past the edge 20. There may be one or more ingress and egress routes into the shelter assembly 12.

In this example of the shelter assembly 12 in FIG. 1 there are open ends defined by edge 20 and the opposing edge. It should be appreciated that there may be a single opening at edge 20 with a closed opposing side or there may be openings at each lateral edge of the panel 18 allowing the fish F to completely pass through the shelter assembly 12. More openings are also possible.

The attachment points 16 allow the shelter assembly 12 to be adhered to an interior surface of the tank assembly 38. The attachment points 16 may be characterized as suction cups that adhere to the interior surface of the tank assembly in any location and any orientation that the user desires. This also allows the shelter assembly 12 to be installed in a wide variety of different tank assemblies 38 that were not necessarily intended to include the shelter assembly 12. The device can be retrofitted into any existing tank. Once installed, the shelter assembly may be repositioned or removed for cleaning with ease.

The attachment points 16 may also be characterized as any other means to attach the shelter assembly 12 to the interior wall of the tank assembly 38. For example, the attachment points 16 may be pads onto which an adhesive is applied to stick the shelter assembly 12 inside the tank assembly 12.

The attachment points may be comprised of magnets that have a corresponding attractive material that pinches the glass between an interior and exterior magnetically attractive element. For example, two magnets or a magnet and a ferrous counterpart may each be on opposite sides of the clear glass panel to which the shelter assembly 12 is affixed.

Likewise, any method that will allow the shelter assembly 12 to be held against a side wall of the tank assembly 38 may be suitable for practicing the method of attracting a fish to the side wall the tank. A hook placed over a top rim of the tank assembly 38 and holding the shelter assembly against a side wall of the tank assembly 38 may also be suitable. A stand or legs could also be placed on the bottom of the tank to support the shelter assembly.

The critical aspect is that an area to provide shelter and apparent protection to marine life be provided adjacent to a panel of the tank assembly 38 to attract and hold the marine life close to that panel to allow for easy viewing through the clear side of the tank.

Yet referring to FIG. 1, shelter assembly 14 demonstrates several variations of the inventive concept. For example, instead of the curved panel 18 of shelter assembly 12, shelter assembly 14 has a more angular structure comprised of panels 28, 30 and 32. Although shelter assembly 14 shows a generally rectangular cross-section, other geometric profiles are readily suitable and within the scope of the invention.

For example, two panels may provide a triangular cross-section or four panels may provide a pentagonal cross-section or other number may provide a corresponding cross-sectional shape. However, each should have an area through which the marine life nestled inside can be plainly viewed through the side wall of the tank assembly 38.

By having a volume inside, for any version of the shelter assembly the marine life in the tank assembly 38 instinctively seeks refuge and protection within. An innate sense natural to the fish or other marine life causes them to seek and remain in a closed and protected environment provided by the shelter assembly. By having that shelter assembly against a clear side wall of the tank, enhanced viewing for those animals inside the tank is achieved.

FIG. 1 shows an optional feature of the shelter assembly 14 to be an aperture 36 that is provided in the upper panel 28. In this example, the shelter assembly 14 is located on an interior wall of the tank to position the panel 28 at or about the waterline 34 of the tank. The aperture 36 provides an ingress route for a user to deposit food or another object to the fish therein. The aperture 36 may also allow the fish to gulp air or blow bubbles.

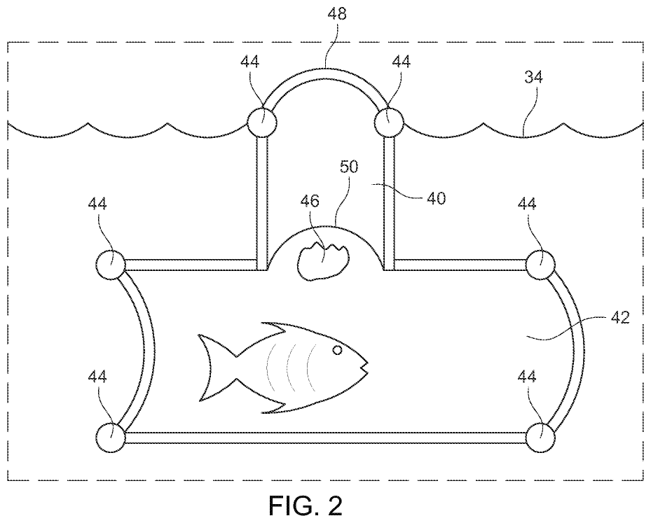

FIG. 2 shows a similar example where a semi tubular horizontal panel 42 is connected to a semi tubular vertical panel 40 at a joint 50. Attachment points 44 affix this shelter assembly to a side wall of the tank assembly so that the rim 48 is at about the waterline 34. The rim 48 may also be placed above or below this waterline 34. This allows a user to deposit food 46 or other object to the interior of this shelter assembly. This can attract a fish into the shelter assembly or can encourage a fish to remain in the shelter assembly longer.

Similarly, the aperture 36 in shelter assembly 14 or the vertical panel 40, shown in FIG. 2, may be used as a breathing port. For example, some fish, such as bettas, have habits of sipping air or blowing bubbles. By having an opening on an upper side of the shelter assembly at or near the waterline 34, the behaviors of certain fish may be accommodated. This can encourage a fish to enter and remain inside a shelter assembly for longer viewing periods.

The attachment points 44 are similar to the alternate versions of attachment points 16 and 26, described above. Any of the attachment points can be any means to temporarily or permanently affix the shelter devices to the interior surface of the tank assembly 38.

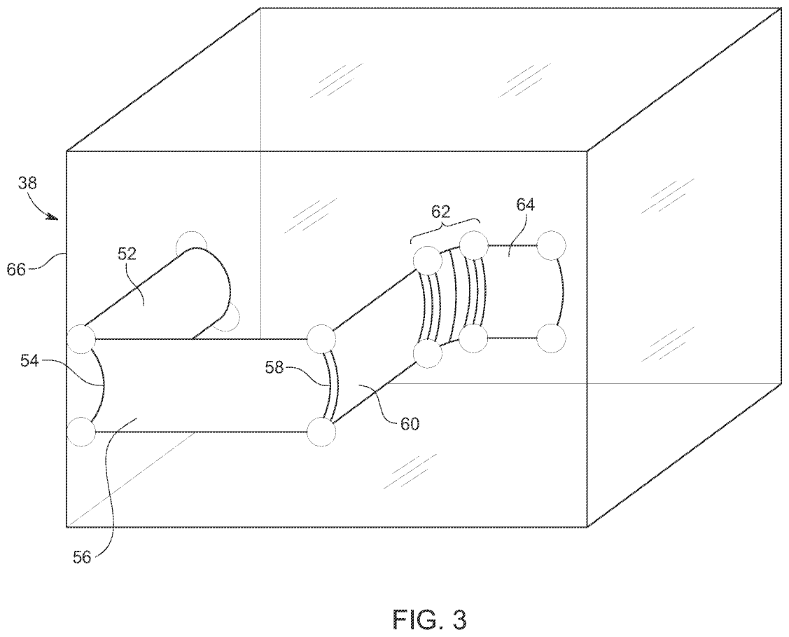

FIG. 3 shows a tank assembly 38 including optional elements of an embodiment of a shelter assembly. Panel 52 and panel 56 are joined together at joint 54 to attach to two separate walls of the tank assembly 38 straddling both sides of the corner 66.

Similarly, panel 56 and panel 60 are joined on a single wall of the tank assembly 38. However, in this example the panel 60 is not parallel to panel 56. Instead, the joint 58 allows an angular connection between panel 56 and panel 60 so that the fish inside the shelter can swim through panel 60 to a higher level in the water. Panels 56 and 60 may be permanently joined together at joint 58. Alternatively, the joint 58 may be fabricated at a complementary angle between panel 56 and panel 60 so that they join sufficiently to afford protection and calm to the sea life within the shelter assembly.

An optional flexible segment 62 is provided between panel 60 and panel 64. This flexible segment 62 can be used to place panels on either side of a corner between walls of the tank assembly 38 or may connect panels 60 and 64 at any desired angle.

Any of the panels may be made from materials having specified opacity. Some versions of the panels may be entirely translucent. Other panels may include a treatment to limit the amount of light that passes through that panel. For example, a surface of a panel may be partially frosted to limit the light transmitted through the panel.

The panels may be formed from generally rigid materials such as plastics, metal, ceramic, porcelain or glass. Other rigid and durable materials may also be suitable if they can hold the relief shape and to be affixed to an interior wall of a tank assembly 38. The fish will remain visible through the unobstructed clear side wall of the tank for viewing because the panel material should not substantially block viewing of the interior of the shelter assembly through the clear side wall of the tank onto which it is attached.

The panels may also include a colorant or be tinted to a specified shade. The panels may include light filtering treatments such as polarization or ultraviolet filters. Different types of marine life may be attracted to or repelled by certain color, filter and/or degrees of opacity. Combinations of these characteristics are desired for applications targeting certain fish or with particular types of tank lighting.

For example, a betta fish will generally tend to prefer and enter a translucent panel but may be reticent to enter a shelter with opaque panels. Other marine life, such as an aquatic salamander, prefers an opaque shelter that may appear to provide greater threat protection. Other fish and marine animals may prefer different colors or to have certain wavelengths filtered through the panel walls. The characteristics of the optics of the panels may be considered in combination with a light source illuminating the interior of the tank assembly 38.

The opacity of a particular panel may also provide shelter in the form of shade from the illumination on the interior of the tank. This may provide comfort to marine life and encourage them to remain inside the shelter assembly longer for better viewing.

The panels may also include a textured treatment to adjust the level of obscurity. For example, a crazed, crackled, mottled, etched, wavy, dimpled, wrinkled or other textured treatment to limit to varying degrees the ability of the marine life to see through the panel. This can affect their sense of threat level and can improve the effectiveness of the shelter. If a fish cannot see through the shelter it may not perceive any other fish as threats and therefore may be more tranquil with a feeling of safety inside the shelter assembly.

The level of optical clarity and obscurity may be manipulated in the manufacturing process through a range of transparency and translucent embodiments. This may be controlled by material, surface design, ornamentation or other material or surface enhancements that affect the aquatic creature's ability to view through the panel. By having a sense of being enclosed and secure the fish being viewed may be encouraged to enter and remain in the shelter.

Generally, the side wall of the tank assembly 38 onto which the shelter assembly is attached is clear to permit viewing of a fish or other marine life binding sanctuary inside the shelter assembly. By placing the shelter assembly in a location where people have direct access to viewing the side of the tank assembly 38, the marine life is presented for easy viewing. The panel assembly may also provide a background resulting in visual contrast that makes the aquatic life more defined and easier to see and enjoy.

Any of the panel treatments may also be used as a decorative feature in addition to or as an alternative to reasons to encourage particular species or types of aquatic life to enter and remain in a shelter assembly. Any of the panel treatments disclosed herein may be used in combination or individually. For example, a panel may have multiple colors, multiple opacities, ornamentation, visual effects and/or areas with different surface treatments.

The dimensions of the interior volume bounded by the one or more panels in a shelter assembly may also be adjusted for the size and type of marine life targeted. For example, some types of marine life prefer a compact and more tightly enclosed volume. Whereas, others may not enter a tightly confined space. Larger fish may require larger shelter assemblies. Smaller fish may require smaller shelter assemblies. Some fish may group or school into a shelter assembly dimension for such activity. Certain species efficient may be encouraged to mate in such confines or to lay and tend eggs, hatchlings or fry.

An effective version of the shelter assembly may be described as partial pipes or partial tubes with an open side facing the side wall of the tank assembly 38 that bound the interior volume where the fish can position itself. Other shapes may be equally effective and may offer a different ornamental or aesthetic form. For example, partial cubes, partial spheres or other irregular shapes resembling rocks, coral or other natural features may be equally effective and provide a degree of aesthetics to fit into other features of the tank.

Similarly, the size, shape and dimension of the ingress and egress openings for the marine life may affect the look and performance of the shelter assembly. Having a single ingress or multiple ingress features may be used to encourage or discourage particular marine life. In another example, multiple ingress routes may be provided without a direct line of sight between those ingress routes. In other words, the ingress routes are on different sides of a visual barrier or around a corner or bend in the shelter structure.

An example of this is shown in FIG. 3 where panel 52 is on a different but adjacent wall from panel 56. A fish entering panel 52 will not see the egress from panel 56 to panel 60 because it is around the corner 66. Similarly, a shelter assembly configured similar to that in FIG. 2 may be entirely submerged in the water allowing the marine life to enter and exit from a side or from the upper rim 48.

Multiple panels may be placed adjacent to each other and affixed with their respective attachment points to the side wall to maintain their relative positions. Adjacent panels may also be snapped or clipped together to form more elaborate shelter assemblies.

The example shown in FIG. 3 is an example of shelter assembly with panels at multiple depths and in multiple configurations. Any combination of any of the panels and configurations disclosed herein may be used interchangeably and remain within the inventive concept provided herein.

The interior surface of the shelter assemblies may optionally include small pits, crevices or micro-chambers. These may be constructed into the device to facilitate habitation by live food sources such as copepods, amphipods, worms, daphnia and other similar creatures to further increase the visits to the shelter device by the fish.

It should be appreciated that the terms tank and fish tank are intended to include any type of enclosure that holds an animal. This includes, for example, common fish tanks, terrariums, fish bowls and other structures with at least one clear side for observing the creatures inside with the present device or without. These enclosures may be fresh water, brackish, marine, completely dry or with a water feature combined with a dry area. These terms are used interchangeably to show an example of the scope of animal life, environment and structure and are not intended to be limiting.

Generally, the term fish refers to any creature using the present device and method. A tank generally includes any enclosure containing a clear surface in which to place the device. A side wall of tank is also used interchangeably with wall of enclosure, or wall of tank or viewing wall of enclosure and are used for illustration and not intended to be limiting to a specific type.

Similarly, the terms fish is intended to encompass all animals found in aquariums, terrariums and other animal structures. For example, this may include any fish reptiles, amphibians, arachnids, insects or other creature. It includes both aquatic and non-aquatic, fresh water and salt water. The term marine is inclusive of other environments and is provided to be illustrative and not limiting.

An important version of the invention can be fairly described as a method of drawing fish (or any animal living in a tank) to an edge of a fish tank for better viewing. The fish tank should have at least one clear wall through which viewers look to observe the animal life. A shelter assembly is provided comprised of a panel that has at least one attachment point. The attachment point is used to affix the shelter assembly to an interior surface of the transparent wall of the tank. The panel is formed with a relief away from an interior surface of the transparent wall so that an interior shelter volume is created which is bounded by the panel and the transparent wall of the fish tank. This also creates an ingress and egress route between the panel and the transparent wall of the tank so that the animal life can enter and exit the interior volume of the shelter. The shelter volume is dimensioned to fit the particular animal life in the tank. Optionally, an upper side of the shelter may have an aperture through which to deposit food or to allow the fish to contact the air above the surface of the water, if there is water in the tank. Optionally, the panel may have a treatment such as a texturing or a coloring or be partially opaque fully opaque or clear, or may have a light filtration treatment applied to it. Optionally, a plurality of shelter assemblies may be connected adjacent to each other and affixed to the interior surface of the wall of the tank. Optionally the interior of the shelter assembly may include an indentation or feature to encourage the establishment of live food sources to further encourage the fish to enter and remain in the shelter assembly.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

1. A method of drawing an animal to view, the method comprised of:
providing a tank assembly having a transparent wall;
placing the animal inside the tank assembly;
providing a shelter assembly comprising an elongated panel shaped as a partial tube along its length; the elongated panel shaped as a partial tube along its length has attachment points at locations used for connecting the elongated panel shaped as a partial tube along its length to the transparent wall of the tank assembly;
the attachment points allow for easy removal and repositioning of the shelter assembly at any vertical position onto any wall of the tank;
affixing the attachment points to an interior surface of the transparent wall of the tank assembly that is located spaced above the bottom the transparent wall of the tank assembly;
the elongated panel shaped as a partial tube along its length is formed with two opposing edges positioned immediately adjacent to the transparent wall of the tank assembly and between the two opposing edges is formed the partial tube of the elongated panel shaped as a partial tube along its length; the partial tube shape is formed at each of the two opposing edges, and both of the partial tube edges create a substantially hollow opening entirely through the partial tube, to provide a large space for the animal to swim or crawl into or through; the two opposing edges thereby providing both a shelter volume bounded by the elongated panel shaped as a partial tube along its length and the transparent wall, and an ingress between the elongated panel shaped as a partial tube along its length and the transparent wall of the tank assembly for the animal to voluntarily enter and exit the shelter volume; wherein the shelter volume is dimensioned to fit the animal.

2. The method of drawing an animal to view in claim 1, further characterized in that the elongated panel shaped as a partial tube along its length is at least one of: textured, colored, partially opaque, fully opaque or light filtered.

3. The method of drawing an animal to view in claim 1, further characterized in that an upper side of the shelter assembly has an aperture dimensioned to accept passage of a preselected food into the shelter volume.

4. The method of drawing an animal to view in claim 1, further characterized in that a plurality of shelter assemblies are affixed adjacent to each other on the interior surface of the transparent wall of the tank assembly.

5. (canceled)

6. The method of drawing an animal to view in claim 1, further characterized in that the elongated panel shaped as a partial tube along its length of the shelter assembly is clear.

7. The method of drawing an animal to view in claim 1, further characterized in that a plurality of shelter assemblies as defined in claim 1, are affixed together on the interior surface of the transparent wall of the tank assembly and are configured so that a plurality of shelter volumes of the adjacent shelter assemblies are open and contiguous so that an animal swims continually through all of the plurality of adjacent shelter assemblies.

8. (canceled)

9. The method of drawing an animal to view in claim 4, further characterized in that a plurality of shelter assemblies are affixed together on the interior surface of the transparent wall of the tank assembly and are configured so that shelter volumes of adjacent shelter assemblies are open and contiguous so that an animal swims continually through all of the adjacent shelter assemblies.

10. The method of drawing an animal to view in claim 1, further characterized in that only one of the partial tube shaped edges is completely hollow.

11. A method of drawing an animal to view, the method comprised of:
providing a tank assembly having a transparent wall;
placing the animal inside the tank assembly;
providing a shelter assembly comprising a panel, the panel is a U-shaped rectangular elongated panel with an opening of a rectangular U-shape elongated panel facing the transparent wall of the tank assembly; the U-shaped rectangular elongated panel has attachment points at locations used for connecting the U-shaped rectangular elongated panel to the transparent wall of the tank assembly;
affixing the attachment points to an interior surface of the transparent wall of the tank assembly that is located spaced above a bottom the transparent wall of the tank assembly;
the U-shaped rectangular elongated panel is formed with two opposing edges positioned immediately adjacent to the transparent wall of the tank assembly and between the two opposing edges is formed the rectangular U-shape of the U-shaped rectangular elongated panel;
the rectangular U-shape is formed across length of the U-shaped rectangular elongated panel, with a space within one or both of the U-shaped edges of the rectangular panel edges creating a substantially hollow opening on one or both ends, providing a space for the animal to swim or crawl into; the two opposing edges thereby providing both a shelter volume bounded by the U-shaped rectangular elongated panel and the transparent wall, and an ingress between the U-shaped rectangular elongated panel and the transparent wall of the tank assembly for the animal to voluntarily enter the shelter volume at either or both ends; wherein the shelter assembly is dimensioned to fit the animal.

12. The method of drawing an animal to view in claim 11, further characterized in that the U-shaped rectangular elongated panel is at least one of: textured, colored, partially opaque, fully opaque or light filtered.

13. The method of drawing an animal to view in claim 11, further characterized in that an upper side of the shelter assembly has an aperture dimensioned to accept passage of a preselected food into the shelter volume.

14. The method of drawing an animal to view in claim 11, further characterized in that a plurality of shelter assemblies are affixed adjacent to each other on the interior surface of the transparent wall of the tank assembly.

15. The method of drawing an animal to view in claim 11, further characterized in that a plurality of shelter assemblies, are affixed together on the interior surface of the transparent wall of the tank assembly and are configured so that shelter volumes of adjacent shelter assemblies are open and contiguous so that an animal swims continually through all of the adjacent shelter assemblies.

16. The method of drawing an animal to view in claim 11, further characterized in that a plurality of shelter assemblies are affixed together on the interior surface of the transparent wall of the tank assembly and are configured so that shelter volumes of adjacent shelter assemblies are open and contiguous so that an animal swims continually through all of the adjacent shelter assemblies.

17. The method of drawing an animal to view in claim 11, further characterized in that only one of the U-shaped edges of the rectangular elongated panel edges creates a substantially hollow opening.

18. A method of drawing an animal to view, the method comprised of:
providing a tank assembly having a transparent wall;
placing the animal inside the tank assembly;
providing a shelter assembly comprising a panel, the panel is an elongated panel having a shape of a partial tube along its length; the elongated panel having a shape of a partial tube along its length has attachment points at locations used for connecting the elongated panel having a shape of a partial tube along its length to the transparent wall of the tank assembly;
the attachment points allow for easy removal and repositioning of the shelter assembly;
affixing the attachment points to an interior surface of the transparent wall of the tank assembly that is located spaced above a bottom of the transparent wall of the tank assembly;
the elongated panel having a shape of a partial tube along its length is formed with two opposing edges positioned immediately adjacent to the transparent wall of the tank assembly and between the two opposing edges is formed the partial tube shape of the elongated panel having a shape of a partial tube along its length;
the partial tube shape is formed at each opposite edge of the elongated panel having a shape of a partial tube along its length, and both ends of the partial tube shaped edges are substantially hollow, to provide a space for the animal to swim or crawl into; the two opposing edges thereby providing both a shelter volume bounded by the panel and the transparent wall, and an ingress at only a first end of the partial tube between the elongated panel having a shape of a partial tube along its length and the transparent wall of the tank assembly for the animal to voluntarily enter the shelter volume; and
wherein the shelter volume is dimensioned to fit the animal.

19. The method of drawing an animal to view method of drawing an animal to view as in claim 11 further characterized in that the U-shaped rectangular elongated panel is manufactured to have a surface resembling rocks or coral.

20. The method of drawing an animal to view method of drawing an animal to view as in claim 1 further characterized in that the elongated panel shaped as a partial tube along its length is manufactured to have a surface resembling rocks or coral.
